(19) United States
(12) Patent Application Publication
(10) Pub. No.: US 2025/0232907 A1
(43) Pub. Date: Jul. 17, 2025

(54) COMPOSITE LAMINATED SOFT MAGNETIC RIBBON WITH CONTROLLED PROPERTY

(71) Applicant: ECDL LIMITED LIABILITY COMPANY, Kawasaki-shi, Kanagawa (JP)

(72) Inventors: Kazushi YAMAUCHI, Saitama-shi, Saitama (JP); Ryosaku INAMURA, Hadano-shi, Kanagawa (JP)

(21) Appl. No.: 18/855,642

(22) PCT Filed: Jul. 21, 2023
(86) PCT No.: PCT/JP2023/026712

§ 371 Date: Oct. 10, 2024

(30) Foreign Application Priority Data
Aug. 2, 2022 (JP) 2022-123636

(51) Int. Cl. H01F 27/25; H01F 1/147

(52) U.S. Cl. CPC H01F 27/25; H01F 1/14766

(57) ABSTRACT

A magnetic part is produced as a composite laminated soft magnetic ribbon by laminating a plurality of kinds of soft magnetic metal ribbons having different characteristics and having an equal width, the soft magnetic metal ribbons including an amorphous alloy ribbon and a nanocrystal alloy ribbon, and piling and then fixing a plurality of the laminated soft magnetic ribbons. A wider magnetic part is produced from a composite laminated soft magnetic ribbon acquired by piling and then fixing a plurality of laminated soft magnetic ribbons, wherein the laminated soft magnetic ribbon is formed by laminating one or a plurality of layers having a narrower amorphous alloy ribbon and a nanocrystal alloy ribbon aligned over a wider silicon steel sheet ribbon such that the total width of the narrower amorphous alloy ribbon and the nanocrystal alloy ribbon can be substantially equal to the width of the wider silicon steel sheet ribbon.

### TECHNICAL FIELD

The present invention relates to a composite laminated soft magnetic ribbon, which is soft magnetic ribbons such as a silicon steel sheet ribbon, an amorphous alloy ribbon, and a nanocrystal alloy ribbon overlaid with each other. It relates to manufacturing of a core, a reactor, a toroidal core, a bulk laminate, and a motor for a transformer, a stator core, a rotor core, and a magnetic circuit for a power generator and the like using a composite laminated soft magnetic ribbon.

### BACKGROUND ART

An amorphous alloy ribbon is produced by rapid cooling from its molten state and does not hold a crystal structure at the atomic level, which is a state not holding a certain periodic structure under an electron microscope and x-ray diffraction. Therefore, an amorphous alloy ribbon produced at a rapid cooled state typically undergone annealing to eliminate internal stresses at a lower temperature than a crystallization temperature to have a softer magnetic property further for use.

Since an amorphous alloy ribbon is manufactured by rapid cooling from a molten state, the ribbon has a width of about 20 cm. Presently, manufacturing and utilization of wide ribbons are limited.

While an amorphous alloy ribbon can be used for manufacturing soft magnetic ribbons having a variety of properties, limited kinds of soft magnetic ribbons are generally on the market. Although it is known that a soft magnetic characteristic and iron loss of an amorphous alloy ribbon mainly containing normal iron are much better than those of a silicon steel sheet ribbon and the like, its only imperfection is that it has magnetic characteristics such as permeability and iron loss deteriorated by application of thermal contraction and residual distortion of a resin due to bonding since the amorphous alloy ribbon has a magnetostriction constant higher than those of a nanocrystal alloy ribbon and a silicon steel sheet ribbon.

A silicon steel sheet ribbon that is one of soft magnetic ribbons has a high saturation magnetic flux density, which allows reduction of the volume and weight of magnetic parts. An amorphous alloy ribbon and a nanocrystal alloy ribbon have magnetic characteristics such as permeability and iron loss superior to those of a silicon steel sheet ribbon, and magnetic parts thereof are excellent in energy-saving. Since a nanocrystal alloy ribbon has good magnetic characteristics including magnetostriction, its applications to magnetic parts have been advanced, but its only imperfection is low rigidity.

Optimally producing a magnetic part by using an amorphous alloy ribbon can achieve 97% or higher energy efficiency of a transformer or a motor, which is suitable for energy-saving. Also, since a nanocrystal alloy ribbon has a lower magnetostriction, limitations in manufacturing such as machining and molds may be highly possibly alleviated.

Since an amorphous alloy ribbon and a nanocrystal alloy ribbon generally have a thickness of about 0.03 mm, that is much thinner than a silicon steel sheet, the amorphous alloy ribbon and the nanocrystal alloy ribbon have lower eddy current loss and are often wound and laminated for utilization.

As described above, each of these soft magnetic ribbons has its merits and demerits, sufficient performance cannot be acquired if it is used alone to construct a magnetic part. In the present circumstances, attempts to enhance their characteristics in combination with another material are hardly made, devices are constructed with a silicon steel sheet ribbon alone, an amorphous alloy ribbon alone, or a nanocrystal alloy ribbon alone.

According to Patent Literature 1, in order to secure a mechanical strength or rigidity, which is the only imperfection of a nanocrystal alloy laminated core, a support member is used which holds a non-magnetic body in the direction of lamination of a laminated block.

According to Patent Literature 2, a tape-wound magnetic core manufacturing method is applied including crystallizing a portion of an amorphous alloy ribbon that can be nanocrystallized, selecting an amorphous alloy ribbon having a similar shrinking percentage thereto, selecting a nanocrystal alloy ribbon having a stable characteristic, and subjecting it to nanocrystallization and heat treatment to acquire a stable characteristic.

According to Patent Literature 3, an amorphous iron core transformer by placing amorphous alloy ribbons opposite, aligning the wide and large amorphous alloy ribbons such that the opposed faces of lamination layers are displaced from each other and laminating them.

A method according to Patent Literature 4, pasting 3 rolls of a soft magnetic alloy ribbon by applying an epoxy resin thereto to laminate them into one roll, where laminates of soft magnetic alloy ribbons are bonded by using two kinds of thermoset resin having different glass transition temperatures.

According to a conventional typical manufacturing method, a stator and a rotor of a motor are produced by punching and laminating silicon steel sheets. Since an amorphous alloy ribbon and a nanocrystal alloy ribbon are thin and rigid, the mold for the punching has a short life, and the steps take time for gathering, handling and laminating punched ribbons, the method is not suitable for laminating to produce the stator and the rotor. According to Patent Literature 5, an amorphous alloy ribbon is wound into a fan shape and is applied to a stator iron core for a motor to produce an axial gap motor, which is applied to a fan apparatus.

Patent Literature 6 relies on bonding, and soft magnetic alloy ribbons are piled and laminated while applying a resin thereto and are pressed under heat to produce a laminate.

According to Non-Patent Literature 1, a nanocrystal alloy ribbon is applied to a core for a transformer to examine a characteristic. Non-Patent Literature 2 discloses a low-iron-loss amorphous iron core structure that is configured to keep the shape of the iron core by cutting and laminating an amorphous metallic foil sheet and then inserting it to an iron-core holding member of resin.

### CITATION LIST

### Patent Literature

### Patent Literature 1

Japanese Patent Laid-Open No. 2021-68865

### Patent Literature 2

Japanese Patent Laid-Open No. 2021-9921

### Patent Literature 3

Japanese Patent Laid-Open No. 2013-98349

### Patent Literature 4

Japanese Patent Laid-Open No. 2021-154732

### Patent Literature 5

Japanese Patent Laid-Open No. 2009-284578

### Patent Literature 6

Japanese Patent Laid-Open No. 2007-281314

### Non Patent Literature 1

Kazuhiro Idei, Fumio Kurihara, Yoshinori Sunaga, “Application of Next-Generation Nanocrystalline Soft Magnetic Materials to Transformer Cores”, Toko Takaoka Giho, VOL. 7, (2020), pp. 15-18

### Non Patent Literature 2

Yuji Enomoto, Hirooki Tokoi, Takao Imagawa, Toshifumi Suzuki, Takeshi Obata, Kenichi Souma, “Kokusai Koukouritsukikaku IE5 level wo tasseishita amorufasumota (Amorphous Motor Achieving International High-efficiency Standard IE5 level)”, Hitachihyoron, combined issue for June and July 2015, PP. 50-55

### SUMMARY OF INVENTION

### Technical Problem

Even with conventional various devices, it cannot be said that sufficient characteristics of produced magnetic parts has been acquired. In order to solve the following problems that are still present, providing an approach has been desired which further controls a property and laminates soft magnetic ribbons having different characteristics to produce a magnetic part having an excellent characteristic.

Although a small nanocrystal alloy laminated ribbon can have rigidity enhanced with a mold or the like, there is a problem that a support member is needed for a transformer core in order to secure the mechanical strength and rigidity, that are only imperfections of a large nanocrystal alloy laminated ribbon. Also, when a nanocrystal alloy laminated ribbon is utilized for a core in a motor or a power generator, there is a possibility that noise, vibration, and so on involved in pulling by external force and distortions due to repellent force occur. A transformer using an amorphous alloy ribbon having a large magnetostriction may emit large noise.

Under current circumstances, for both of the amorphous alloy ribbon and the nanocrystal alloy ribbon, the width of the ribbons that can be manufactured is about 20 cm maximum. In order to manufacture a large magnetic product, it is necessary to develop a composite laminated soft magnetic ribbon having a larger width.

Since a nanocrystal alloy ribbon undergoes heat treatment before laminated, it is weaker than before the heat treatment.

For increased efficiency of a motor, it is desired to produce highly-efficient and highly-productive stators and rotors by applying an amorphous alloy ribbon or a nanocrystal alloy ribbon characterized by higher permeability and lower iron loss than a silicon steel sheet. Conventionally, an approach has not been examined which controls the property by a good combination of soft magnetic metals having different characteristics and facilitates the production.

Magnetic products with a soft magnetic ribbon that is ideal from energy-saving viewpoint is to be produced with an amorphous alloy ribbon or a nanocrystal alloy ribbon on which compressive stress caused by a mold is not applied.

The magnetic part to be excited for use varies in accordance with the purpose of usage involving from low power to high power. Magnetic materials therefor may include a material having low coercivity and a low saturation magnetic flux density and a silicon steel sheet material having relatively high coercivity and a high saturation magnetic flux density.

Although a silicon steel sheet having a high magnetic flux density is used as a main constituent in order to reduce the volume and weight of a magnetic part by using a soft magnetic ribbon, the silicon steel sheet has poorer characteristics such as the permeability and iron loss compared with an amorphous alloy ribbon and a nanocrystal ribbon. Therefore, the development of transformers, motors and so on having an amorphous alloy ribbon or a nanocrystal alloy ribbon as a main constituent have been advanced from energy-saving viewpoint though the resulting magnetic parts have increased volumes and weights. In order to produce a large transformer by using a nanocrystal alloy ribbon, a non-magnetic support is required for reinforcement to cover the imperfection of low rigidity. There is a need for development of a composite laminated soft magnetic ribbon, in which nanocrystal alloy ribbon is held and overlaid with a silicon steel sheet or an amorphous alloy ribbon such that the nanocrystal alloy ribbon can be self-supported without use of a support.

The present invention was made in view of these problems, and it is an object of the present invention to provide a composite laminated soft magnetic ribbon by laminating magnetic parts such as a transformer and a motor core based on a combination of advantages of materials in consideration of superiority and imperfections of individual soft magnetic ribbons such as a silicon steel sheet ribbon, an amorphous alloy ribbon, a nanocrystal alloy ribbon, and so on for acquisition of maximum efficiency.

### Solution to Problem

A composite laminated soft magnetic ribbon according to the present invention is acquired by laminating a plurality of kinds of soft magnetic metal ribbons having different characteristics and having an equal width and piling and then fixing a plurality of the laminated soft magnetic ribbons, wherein the plurality of kinds of soft magnetic ribbons always include an amorphous alloy ribbon and a nanocrystal alloy ribbon.

A composite laminated soft magnetic ribbon according to the present invention is acquired by winding a laminated soft magnetic ribbon a plurality of number of times and fixing, wherein the laminated soft magnetic ribbon is formed by laminating an amorphous alloy ribbon and a nanocrystal alloy ribbon both having an equal width.

A composite laminated soft magnetic ribbon according to the present invention acquired by piling and then fixing a plurality of laminated soft magnetic ribbons, wherein the laminated soft magnetic ribbon is formed by laminating one or a plurality of layers having a narrower amorphous alloy ribbon and a nanocrystal alloy ribbon aligned over a wider silicon steel sheet ribbon such that the total width of the narrower amorphous alloy ribbon and the nanocrystal alloy ribbon can be substantially equal to the width of the wider silicon steel sheet ribbon.

A composite laminated soft magnetic ribbon according to the present invention is formed by winding a laminated soft magnetic ribbon a plurality of number of times, the laminated soft magnetic ribbon being formed by aligning a narrower amorphous alloy ribbon and a nanocrystal alloy ribbon over a wider silicon steel sheet ribbon such that the total width of the narrower amorphous alloy ribbon and the nanocrystal alloy ribbon can be substantially equal to the width of the wider silicon steel sheet ribbon, and subsequently winding only the narrower amorphous alloy ribbon and the nanocrystal alloy ribbon aligned such that the total width of the narrower amorphous alloy ribbon and the nanocrystal alloy ribbon can be substantially equal to the width of the wider silicon steel sheet ribbon and fixing them.

### Advantageous Effects of Invention

Combining an amorphous alloy ribbon and a nanocrystal alloy ribbon can provide a magnetic part that keeps a soft magnetic characteristic with less iron loss and that has a weakness in rigidity of the nanocrystal alloy ribbon reinforced by the amorphous alloy ribbon. For example, a small and self-supported transformer causing low noise can be produced. Winding the ribbons to produce the magnetic part can contribute to reduction of working steps, and the magnetic part can be machined to be directly used as a core for use in a stator of an axial gap motor.

By employing a laminated soft magnetic ribbon having a narrower amorphous alloy ribbon and a nanocrystal alloy ribbon aligned over a wider silicon steel sheet ribbon, small excitation current operates in the part of the amorphous alloy ribbon and the nanocrystal alloy ribbon, and by making use of the characteristic that the silicon steel sheet ribbon has high saturation magnetization, a magnetic part such as a stator of a motor in a reduced size that can operate even with large excitation current can be provided.

By winding a laminated soft magnetic ribbon including a combination of an amorphous alloy ribbon and a nanocrystal ribbon by using a silicon steel sheet ribbon having a width of 25 cm or more, a magnetic part for a large transformer, motor, power generator and so on can be produced through reduced operating steps.

### BRIEF DESCRIPTION OF DRAWINGS

FIG. 1 is a diagram showing a composite laminated soft magnetic ribbon according to Embodiment 1.

FIG. 2 is a diagram showing a method for producing a composite laminated soft magnetic ribbon according to Embodiment 2.

FIG. 3 is a diagram showing a composite laminated soft magnetic ribbon produced according to Embodiment 2.

FIG. 4 is a diagram showing a composite laminated soft magnetic ribbon according to Embodiment 3.

FIG. 5a is a diagram showing a method for producing a composite laminated soft magnetic ribbon according to Embodiment 4.

FIG. 5b is a diagram showing a method for producing a composite laminated soft magnetic ribbon according to Embodiment 4.

FIG. 6 is a diagram showing a composite laminated soft magnetic ribbon produced according to Embodiment 4.

### DESCRIPTION OF EMBODIMENTS

The principle of the present invention is described before describing embodiments of the present invention.

Soft magnetic ribbons such as a silicon steel sheet, an amorphous alloy ribbon, and a nanocrystal alloy ribbon are known, but their superiority or inferiority in magnetic characteristics, mechanical characteristics and so on may vary. Most of them include layers of one material laminated to produce a magnetic part. Good characteristics of different ribbons are macro-synthesized for utilization as a composite laminated soft magnetic ribbon.

The composite laminated soft magnetic ribbon according to the present invention holds a nanocrystal alloy ribbon with a silicon steel sheet ribbon, an amorphous alloy ribbon and so on so that it can be constructed from soft magnetic ribbons 100% except for an adhesive, instead of reinforcement with a non-magnetic support, which allows reduction of the volume and weight of magnetic parts.

Such a laminated soft magnetic ribbon using an amorphous alloy ribbon and a nanocrystal alloy ribbon exhibits higher permeability than a silicon steel sheet and can thus provide a magnetic part that achieves energy saving with reduced iron loss.

The laminated soft magnetic ribbon mainly contains a nanocrystal alloy ribbon so that the magnetostriction can be reduced and that the buzzing of the transformer can be reduced. Also, although there is a possibility that a laminated soft magnetic ribbon mainly containing a nanocrystal ribbon causes the core of a motor including it to be distorted by external force, reduction of the distortion of the core can be expected because of its rigidity increased by an amorphous alloy ribbon therein. Compared with cases where one kind of material is used, a laminated soft magnetic ribbon combining advantages of different kinds of materials may be used to increase the possibility of production of a highly-functional products.

A silicon steel sheet ribbon has a wide variety of superiority and has a thickness that is arbitrarily adjustable and may be used to produce a composite laminated soft magnetic ribbon having a width greater than or equal to 25 cm, leading to development of magnetic parts of larger transformers, motors, power generators and so on.

By combining a material having a magnetic material with low coercivity and a material with a high saturation magnetic flux density, the material with low coercivity works up to the saturation magnetic flux density with smaller exciting energy, and when exciting energy is further applied after that, the material with a high saturation magnetic flux density bears it so that a composite material utilizing the mutual advantages can be produced.

### Embodiment 1

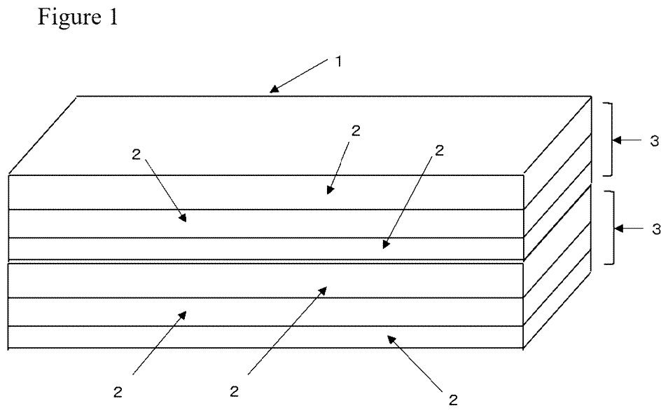

FIG. 1 is a diagram showing a composite laminated soft magnetic ribbon 1 according to Embodiment 1. In order to improve characteristics, a plurality of soft magnetic ribbons 2 of a plurality of kinds and having an equal width and different characteristics are piled and fixed to produce a laminated soft magnetic ribbon 3. The plurality of kinds of soft magnetic ribbons 2 are assumed to always include an amorphous alloy ribbon and a nanocrystal alloy ribbon. As a third soft magnetic ribbon, a silicon steel sheet ribbon or the like may be added. The number of layers to be laminated can be selected as needed in a range from two to five. A plurality of the laminated soft magnetic ribbons 3 are further laminated and fixed to produce the composite laminated soft magnetic ribbon 1. While FIG. 1 shows a diagram in which, in reality, two layers are laminated, about 100 layers, for example, may be laminated to acquire a certain thickness. The fixing may employ a bonding method.

Although the nanocrystal alloy ribbon contributes to improvement of the magnetic characteristic of the resulting magnetic part, when it is used alone, the rigidity is low and it is difficult to be self-supported. Therefore, there is a possibility that the resulting magnetic part is distorted. By using a laminated soft magnetic ribbon in combination with an amorphous alloy ribbon which is a reinforcer for a nanocrystal alloy ribbon, the resulting composite laminated soft magnetic ribbon can keep a good magnetic characteristic and can also be used in a self-supported manner.

The composite laminated soft magnetic ribbon 1 is used which combines a nanocrystal alloy ribbon and an amorphous alloy ribbon from energy-saving viewpoint.

The low rigidity of the nanocrystal alloy ribbon is compensated by the amorphous alloy ribbon so that the composite laminated soft magnetic ribbon 1 holding them can be used as a bulk laminate. Combining four rectangular cuboids can provide a transformer. By punching and laminating them, it can be used as a motor core. An amorphous alloy ribbon has a higher magnetostriction constant, so if it is used for a transformer, it vibrates with alternate current and may cause. However, by controlling the used amount of the amorphous alloy ribbon to be lower than that of the nanocrystal alloy ribbon, the vibration with alternate current can be reduced.

It should be noted that, according to Embodiment 1, the amorphous alloy ribbon and the nanocrystal alloy ribbon are required, a soft magnetic ribbon such as a silicon steel sheet ribbon is used in some cases. On the other hand, although the volume and weight are increased more or less, when an amorphous alloy ribbon and a nanocrystal alloy ribbon without use of a silicon steel sheet ribbon are only used to construct a magnetic part which is driven only by low current, low coercivity and highly reduced iron loss can be achieved. Thus, the magnetic part can be activated with low current, which preferably contributes to energy saving.

### Embodiment 2

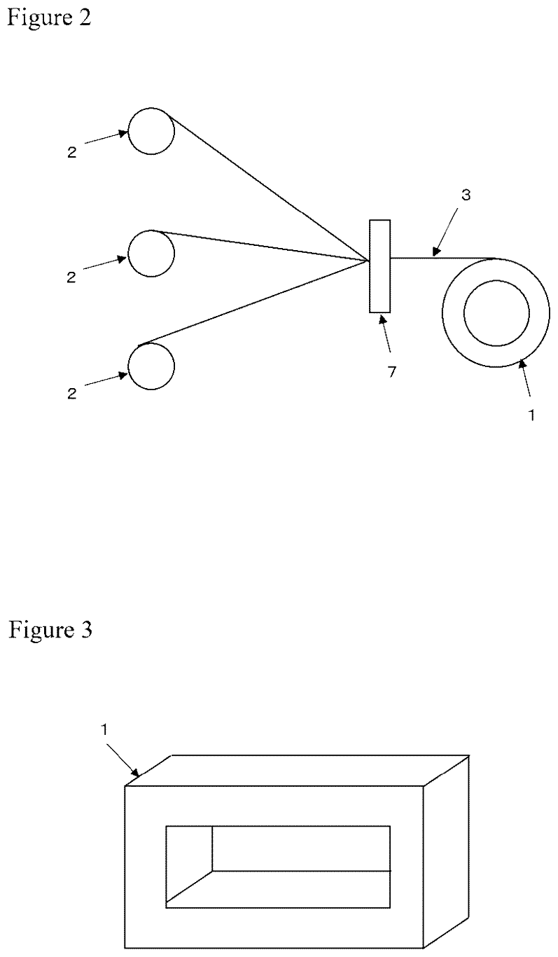

FIG. 2 is a diagram showing a method for producing a composite laminated soft magnetic ribbon 1 according to Embodiment 2.

In order to improve characteristics, a plurality of an amorphous alloy ribbon and a nanocrystal alloy ribbon having an equal width and different characteristics are piled and fixed to produce a laminated soft magnetic ribbon 3, and the laminated soft magnetic ribbon 3 is wound and then fixed to produce the composite laminated soft magnetic ribbon 1.

The number of layers to be piled can be selected as needed in a range from two layers to five layers. Combinations of the soft magnetic ribbons 2 include an alternate arrangement of an amorphous alloy ribbon and a nanocrystal alloy ribbon or an arrangement of one amorphous alloy ribbon and two nanocrystal alloy ribbons, for example, can be selected to adjust the total thickness. The fixing may employ a bonding method so that the mechanical strength and rigidity can be compensated.

The thus produced composite laminated soft magnetic ribbon 1 can be cut as needed to produce a magnetic part for a transformer, a toroidal core, a reactor and so on.

A 2-cm wide amorphous alloy ribbon wound around one reel and 2-cm wide nanocrystal alloy ribbons wound around two reels are prepared. Two nanocrystal alloy ribbons are piled over the amorphous alloy ribbon and are then wound. By winding it 100 times into a 6-cm wide and 2-cm high rectangular, a 1-cm thick composite laminated soft magnetic ribbon 1 as shown in FIG. 3 is produced. The use of the nanocrystal alloy ribbons therein can achieve allows use as a transformer core that exhibits good characteristics and can be self-supported without using a non-magnetic reinforcer. Similar methods may be used to produce a reactor, a motor core and a bulk laminate. Such a combination of soft magnetic ribbons according to Embodiment 2 can provide less hysteresis loss and eddy current loss, reduced iron loss and good soft magnetic characteristic, which are best suitable for energy-saving magnetic parts, like Embodiment 1.

Although an amorphous alloy ribbon is cut and laminated and provided in a casing in a stator of an axial gap motor (see Non-Patent Literature 2) in current circumstances, a columnar core produced from the composite laminated soft magnetic ribbon 1 of Embodiment 2 can be machined, and a coil is wound around it so that it can be used for a stator of an axial gap motor.

When a core part of an axial gap motor is produced with an amorphous alloy ribbon, the amorphous alloy ribbon is bonded and set with a resin for fixing the core around which the amorphous alloy ribbon is wound. Due to the bonding and setting, stress is applied to the core, and large magnetostriction deteriorates the soft magnetic characteristic. However, in the core part produced from the composite laminated soft magnetic ribbon 1 of Embodiment 2, the use of the nanocrystal alloy ribbon can reduce the deterioration of the soft magnetic characteristic. Therefore, the operating efficiency of the manufacturing steps can be increased.

### Embodiment 3

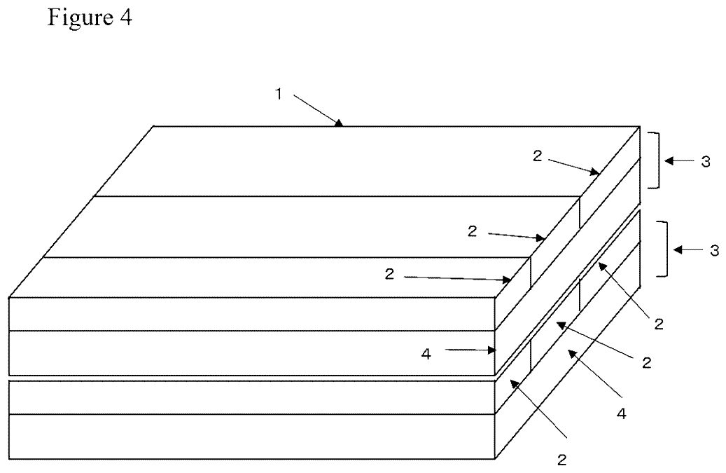

FIG. 4 is a diagram showing a composite laminated soft magnetic ribbon 1 according to Embodiment 3.

A laminated soft magnetic ribbon 3 is formed by laminating one or a plurality of layers having a narrower amorphous alloy ribbon and a nanocrystal alloy ribbon as the soft magnetic ribbons 2 aligned over a wider silicon steel sheet ribbon 4 such that the total width of the narrower amorphous alloy ribbon and the nanocrystal alloy ribbon can be substantially equal to the width of the wider silicon steel sheet ribbon 4. A plurality of the laminated soft magnetic ribbons 3 are further laminated and fixed to produce the composite laminated soft magnetic ribbon 1. While the laminated soft magnetic ribbon 3 in FIG. 4 includes one silicon steel sheet ribbon 4 and one soft magnetic ribbon 2, one silicon steel sheet ribbon and a plurality of soft magnetic ribbons may be laminated to form the laminated soft magnetic ribbon 3. Also, while FIG. 4 shows a diagram having two laminated soft magnetic ribbons 3 are laminated to form the composite laminated soft magnetic ribbon 1, about 100 layers, for example, may be laminated in reality to acquire a certain thickness.

The composite laminated soft magnetic ribbon 1 may be machined as needed to produce a magnetic part such as a core for a motor, a bulk laminate, a core member of a power generator. While a plurality of teeth, which are a part of a stator, are connected into one ring shape to produce one large motor core with a conventional amorphous alloy ribbon, this embodiment can facilitate the production of wider motor core than before through one press punching operation.

The greatest features that the part including the amorphous alloy ribbon and the nanocrystal alloy ribbon of the composite laminated soft magnetic ribbon 1 operates with small excitation current and that the silicon steel sheet ribbon has high saturation magnetization are the most suitable for a magnetic part such as a stator of a small motor that can utilize the size reduction achieved maximumly by the features. Also, it is also suitable for a magnetic part which operates with the nanocrystal alloy ribbon and the amorphous alloy ribbon at a lower output and also operates with the silicon steel sheet ribbon having high saturation magnetization though the energy efficiency decreases during an operation with a maxim electricity use, and, when it is applied to a transformer, the transformer operates by using the nanocrystal alloy ribbon and the amorphous alloy ribbon with power consumption during standby. In a case of a motor is used, the motor operates similarly with the nanocrystal alloy ribbon and the amorphous alloy ribbon in a low output mode and operates with a part of the silicon steel sheet ribbon in addition in a maximum output mode. Although the silicon steel sheet ribbon is inferior in soft magnetic characteristic to the nanocrystal alloy ribbon and the amorphous alloy ribbon and has the imperfection of increased energy consumption, it does not create large vibration in a transformer since the silicon steel sheet ribbon exhibits smaller magnetostriction than that of the amorphous alloy ribbon.

### Embodiment 4

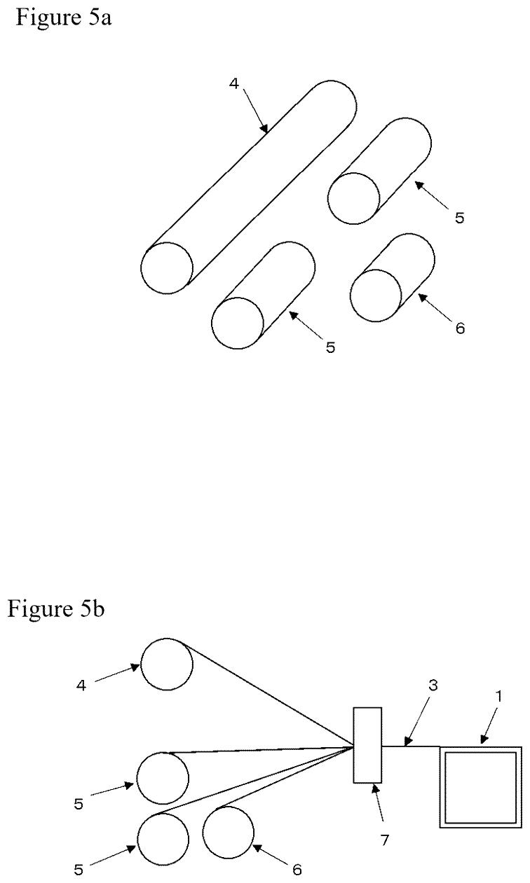

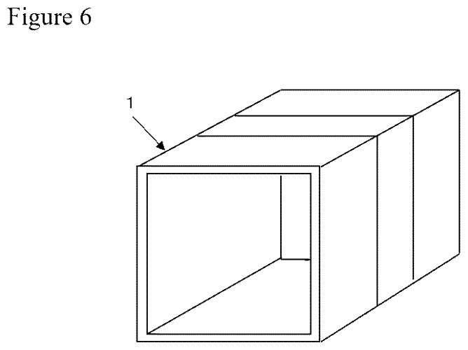

FIGS. 5a and 5b are diagrams showing a method for producing a composite laminated soft magnetic ribbon 1 according to Embodiment 4. As shown in FIG. 5a, a 0.1-mm thick, 50-cm wide and 6-m long silicon steel sheet ribbon 4 wound around one reel, a 0.03-mm thick, 20-cm wide and about 1000-m long amorphous alloy ribbon 5 wound around two reels, and a 0.02-mm thick, 10-cm wide and about 1000-m long nanocrystal alloy ribbon 6 wound around one reel are prepared. The ribbons are pulled out from the respective reels, and the 20-cm wide amorphous alloy ribbon and the 10-cm wide nanocrystal ribbon and the 20-cm wide amorphous alloy ribbon are aligned and piled over the 50-cm wide silicon steel sheet ribbon 4 as shown in FIG. 5b such that the total width can be equal to 50 cm equal to that of the silicon steel sheet to form the laminated soft magnetic ribbon 3 and are wounded through a guide frame 7. In order to acquire a square 50 cm on a side, the ribbons are wound three turns by bending by 90 degrees at four positions per turn. Winding the 20-cm wide amorphous alloy ribbon, the 10-cm wide nanocrystal alloy ribbon, and the 20-cm wide amorphous alloy ribbon are continued up to 30 rounds by keeping a total width of 50 cm even after the silicon steel sheet ends, and when the thickness is equal to 1.29 mm, the amorphous alloy ribbons are cut. In a case where the amorphous alloy ribbons and the nanocrystal alloy ribbon have an equal thickness, the nanocrystal alloy ribbon is also cut to complete here. However, in the embodiment above, the thickness of the nanocrystal alloy ribbon is less, the winding of the nanocrystal alloy ribbon alone is continued 15 more rounds. If it is recognized that the difference between the total thickness of the amorphous alloy ribbons wound 30 times and the total thickness of the nanocrystal alloy ribbon wound 45 times is equal to or less than 0.1 mm, the nanocrystal alloy ribbon is also cut to produce the composite laminated magnetic ribbon 1 shown in FIG. 6.

After the thus produced, cube-like composite laminated magnetic ribbon 1 is fixed, it is cut at four corners to acquire four plates each having a size of 50 cm×50 cm×1.29 mm. The plates are press punched to acquire a motor core material.

The composite magnetic ribbon 1 of this embodiment can be used as a power-generator core.

The magnetic parts produced by this embodiment, such as a motor core and a power-generator core are advantageously no longer limited with respect to the width of the ribbons and can use a wide composite soft magnetic ribbon. Since producing a large transformer or a motor core requires a wider and thicker composite ribbon wound more turns, the method according to this embodiment is suitable.

Here, the features of the magnetic parts produced according to Embodiments 1 to 4 can be compared and summarized as follows.

Since the magnetic parts produced by Embodiments 1 and 2 involve energy-saving operations of a nanocrystal alloy ribbon and an amorphous alloy ribbon with excellent soft magnetic characteristics though the saturation magnetic flux density is low during use in a low output mode, the methods of Embodiments 1 and 2 are suitable for magnetic parts that require energy saving in a low output mode.

The magnetic parts produced by Embodiments 3 and 4 generate a large amount of heat since the silicon steel sheet ribbon with large iron loss is always used, which is slightly disadvantageous from energy saving viewpoint. However, in a low output mode, the amorphous alloy and the nanocrystal alloy operate so that a certain degree of energy saving characteristic can be acquired. After switching to a high output mode, even the nanocrystal alloy ribbon and the amorphous alloy ribbon saturate, the silicon steel sheet ribbon with a high saturation magnetic flux density does not saturate and operates. The methods of Embodiments 3 and 4 are suitable for magnetic parts to be used in a wide range from a low output mode to a high output mode.

Assuming to produce the same magnetic part such as a transformer or a motor core, winding and laminating is involved in Embodiments 2 and 4, which can advantageously achieve reduction of the number of steps for magnetic part manufacturing compared with Embodiments 1 and 3 not winding but requiring the steps of punching and laminating.

### INDUSTRIAL APPLICABILITY

According to the present invention, since a magnetic part having an excellent characteristic such as a bulk laminate, a transformer, a reactor, a core for a motor and a core member for a power generator can be produced from a composite laminated soft magnetic ribbon incorporating a combination of advantages of various soft magnetic ribbons while the reduction of the number of manufacturing steps, the industrial applicability is high.

### REFERENCE SIGNS LIST

1 composite laminated soft magnetic ribbon
2 soft magnetic ribbon
3 laminated soft magnetic ribbon
4 silicon steel sheet ribbon
5 amorphous alloy ribbon
6 nanocrystal alloy ribbon
7 guide frame

1-6. (canceled)

7. A composite laminated soft magnetic ribbon acquired by piling and then fixing a plurality of laminated soft magnetic ribbons, wherein the laminated soft magnetic ribbon is formed by laminating one or a plurality of layers having a narrower amorphous alloy ribbon and a nanocrystal alloy ribbon aligned over a wider silicon steel sheet ribbon such that the total width of the narrower amorphous alloy ribbon and the nanocrystal alloy ribbon can be substantially equal to the width of the wider silicon steel sheet ribbon.

8. A composite laminated soft magnetic ribbon formed by winding a laminated soft magnetic ribbon a plurality of number of times, the laminated soft magnetic ribbon being formed by aligning a narrower amorphous alloy ribbon and a nanocrystal alloy ribbon over a wider silicon steel sheet ribbon such that the total width of the narrower amorphous alloy ribbon and the nanocrystal alloy ribbon can be substantially equal to the width of the wider silicon steel sheet ribbon, and subsequently winding only the narrower amorphous alloy ribbon and the nanocrystal alloy ribbon aligned such that the total width of the narrower amorphous alloy ribbon and the nanocrystal alloy ribbon can be substantially equal to the width of the wider silicon steel sheet ribbon and fixing them.

9. A composite laminated soft magnetic ribbon, wherein if the narrower amorphous alloy ribbon and the nanocrystal alloy ribbon according to claim 8 do not have an equal thickness, the narrower amorphous alloy ribbon and the nanocrystal alloy ribbon is only wound a plurality of number of times and then one thicker soft magnetic ribbon of the amorphous alloy ribbon and the nanocrystal alloy ribbon is cut while the other soft magnetic ribbon is further wound and is cut when the total thickness of the other soft magnetic ribbon is substantially equal to the thickness of the thicker soft magnetic ribbon and is fixed.

10. A magnetic part produced from the composite laminated soft magnetic ribbon according to claim 7, wherein the magnetic part is one of a core of a transformer and a motor, and a core of a power generator.

11. A magnetic part produced from the composite laminated soft magnetic ribbon according to claim 8, wherein the magnetic part is one of a core of a transformer and a motor, and a core of a power generator.

12. A magnetic part produced from the composite laminated soft magnetic ribbon according to claim 9, wherein the magnetic part is one of a core of a transformer and a motor, and a core of a power generator.
